(19) United States
(12) Patent Application Publication
(10) Pub. No.: US 2005/0282062 A1
(43) Pub. Date: Dec. 22, 2005

(54) Fuel cell electrode, fuel cell and their production processes

(76) Inventors: Takashi Manako, Tokyo (JP); Tsutomu Yoshitaka, Tokyo (JP); Hidekazu Kimura, Tokyo (JP); Ryota Yuge, Tokyo (JP); Yoshimi Kubo, Tokyo (JP)

Correspondence Address: KATTEN MUCHIN ROSENMAN LLP, 575 MADISON AVENUE, NEW YORK, NY, 10022-2585, US

(21) Appl. No.: 11/192,316

(22) Filed: Jul. 28, 2005

Related U.S. Application Data
(63) Continuation of application No. PCT/JP04/01795, filed on Feb. 18, 2004.

(30) Foreign Application Priority Data
Feb. 18, 2003 (JP) 2003-040074

(51) Int. Cl. H01M 4/86; H01M 4/90; H01M 4/88

(52) U.S. Cl. 429/44; 429/42; 502/101

(57) ABSTRACT

A porous metal sheet (489) is used as an electrode substrate and the surface of a metal constituting the porous metal is roughened by etching. A plating layer of a catalyst (491) is formed on the surface on which irregularities are formed. This obtained electrode material is used as a fuel electrode (102) or an oxidizer electrode and these electrodes are bound with the solid electrolyte film (114).

### FIELD OF THE INVENTION

The invention relates to a fuel cell electrode, a fuel cell and processes of producing the fuel cell electrode and fuel cell.

### DESCRIPTION OF THE RELATED ART

With advent of a recent information-oriented society, the amount of information processed in electronic devices such as personal computers has been outstandingly increased, which is accompanied by a significant increase in power consumption in electronic devices. Particularly, portable type electronic devices have problems concerning an increase in power consumption along with an increase in throughput. At present, a lithium ion battery is generally used as the power source in such portable type electronic devices. However, the energy density of the lithium ion battery reaches nearly its theoretical limit. Therefore, there is such a limitation that power consumption must be reduced by restricting the drive frequency of CPUs, to extend the term during which portable type electronic devices are continuously used.

In such a situation, the term during which portable type electronic devices are continuously used is expected to be longer by using a fuel cell having a high heat exchange rate and a high energy density as the power sources of these electronic devices.

The fuel cell is constituted of a fuel electrode and an oxidizer electrode (hereinafter these electrodes are also referred to as “catalyst electrode”) and an electrolyte disposed between these electrodes, wherein fuel is supplied to the fuel electrode and an oxidizer is supplied to the oxidizer electrode to cause an electrochemical reaction thereby generating electricity. Although hydrogen is usually used as the fuel, a methanol reformation type that reforms methanol to generate hydrogen by using methanol that is inexpensive and easily handlable as starting material and a direct type fuel cell utilizing methanol directly as the fuel have been recently developed enthusiastically.

When hydrogen is used as the fuel, the reaction on the fuel electrode is given by the following formula (1):
3H₂→6H⁺+6e⁻ (1)

When methanol is used as the fuel, the reaction on the fuel electrode is given by the following formula (2):
CH₃OH+H₂O→6H⁺+CO₂+6e⁻ (2)

Also, in any case, the reaction on the oxidizer electrode is given by the following formula (3):
3/2O₂+6H⁺+6e⁻→3H₂O (3)

Particularly in the direct type fuel cell, a hydrogen ion can be obtained from an aqueous methanol solution and therefore, a reformer and the like becomes unnecessary, which is very advantageous in applying this fuel cell to portable type electronic device. Also, since this fuel cell uses an aqueous methanol solution as the fuel, energy density is very high.

The catalyst electrode in a conventional fuel cell has a structure in which a catalyst layer is formed on the surface of a gas diffusion layer using a carbon material as the substrate. In such a structure, a collecting member such as an end plate is provided on both surfaces of the catalyst electrode-solid electrolyte film complex in which the solid electrolyte film is disposed between the catalyst electrodes to improve current collecting efficiency of electron which generated in a catalyst electorode. At this time, the collecting member must have a fixed thickness to better the electrical contact between the gas diffusion layer made of carbon and the collecting member made of a metal, and it is difficult to develop a thin type and small-sized and light-weight fuel cell.

In view of the above situation, there is a report concerning techniques using a foam metal made of nickel in place of a carbon porous body as the material of the gas diffusion layer (Patent Document 1). The use of the porous metal sheet betters electrical contact with the collecting member, leading to improved generating efficiency.

However, the structure of the fuel cell described in Patent Document 1 fails to attain a sufficiently small-sized, light-weight and thin type fuel cell because the bulk metal electrode to be the collecting member is formed outside of the electrode though the material of the gas diffusion layer is changed. When a fuel cell is used as a portable device, it must be small-sized and lightened. In the case of, for example, a portable telephone, the weight of the console is as light as about 100 g, the fuel cell must be decreased in weight in the order of gram unit and in thickness in the order of mm unit.

Also, in conventional fuel cells, carbon particles are made to support the catalyst to increase the amount of the catalyst to be supported on the electrode. Hereinafter, the particles made to support the catalyst are called catalyst support carbon particles. In this case, on the fuel electrode, electrons generated on the surface of the catalyst move to the gas diffusion layer through carbon particles. Therefore, it is ideal that all carbon particles are in contact with the gas diffusion layer to secure the efficiency of utilizing the electrons generated by the catalytic reaction.

However, in the solid electrolytic type fuel cell, a solid high-molecular electrolyte is used as the electrolyte which serves as a migration passage of hydrogen ions, and there is therefore the case where the surface of the catalyst support carbon particles are coated with the solid high-molecular electrolyte. Because such catalyst support carbon particles have no contact point with the gas diffusion layer, the migration passage of electrons is not secured and therefore the electrons generated by the catalytic reaction cannot be taken out as electric power.

Also, Patent Document 2 describes an electrochemical device using metal fibers such as SUS. Specific examples of the device include gas sensors, refining apparatuses, electrolytic layers and fuel cells. However, in the examples of this document, the structure of a fuel cell that is actually operated as a battery is not described though there are descriptions concerning examples of the generation of hydrogen by electrolysis. Particularly there are no description as to the means of moving the protons generated on the catalyst to the solid electrolyte film and any fuel cell that actually works as a battery is not disclosed.

Patent Document 1: Japanese Patent Application Laid-Open patent publication No H06-5289

Patent Document 2: Japanese Patent Application Laid-Open patent publication No. H06-267555

### SUMMARY OF THE INVENTION

As mentioned above, it is difficult to make traditional fuel cells thin and light-weight. Also, there is ample room for traditional fuel cells to be improved in the utilization efficiency and collecting characteristics of a catalyst.

The present invention has been made in the above situation and it is an object of the present invention to provide techniques used to develop small-sized and light-weight fuel cells. Another object of the present invention is to provide techniques used to improve the output characteristics of a fuel cell. A further object of the present invention is to provide techniques used to simplify a process of producing a fuel cell.

The present invention provides a fuel cell electrode comprising a porous metal sheet, a catalyst supported by the porous metal sheet and a proton conductor disposed in contact with the catalyst.

The present invention also provides a process of producing a fuel cell electrode, the process comprising a step of supporting a catalyst by a porous metal sheet.

In traditional fuel cell electrodes, the catalyst is connected to a carbon material as a substrate through carbon particles. In the present invention, on the other hand, the catalyst is supported directly on the surface of a metal constituting the porous metal sheet. Here, it is not required for the porous metal sheet to have a uniform structure. For example, the composition of a metal constituting the metal fiber sheet on the surface may be different from that in the inside. The porous metal sheet may have a conductive surface layer. Also in this case, the catalyst is supported directly on the part constituting the sheet.

As mentioned above, the fuel cell electrode according to the present invention has a structure in which the catalyst is supported directly on the surface of a metal constituting the porous metal sheet. Therefore, when this electrode is used, for example, as a fuel electrode, the electrons generated by an electrochemical reaction at the boundary between the catalyst and the electrolyte are resultantly transferred to the porous metal sheet surely and rapidly. Also, when the electrode is used as an oxidizer electrode, the electrons conducted to the porous metal sheet from an external circuit are conducted to the catalyst joined with the porous metal sheet. Also, since the proton conductor is disposed in contact with the catalyst, the migration passage of protons generated on the surface of the catalyst is secured. The fuel cell electrode according to the present invention can utilize the electrons and protons generated by an electrochemical reaction, the output characteristics of the fuel cell can be improved.

The porous metal sheet used in the fuel cell electrode according to the present invention has higher conductivity and hence more excellent current collecting characteristics than carbon materials traditionally used. Therefore, even if a collecting member such as an end plate is not disposed outside of the electrode, current can be surely collected. This makes it possible to develop a small-sized and thin type fuel cell.

Also, because the surface of a carbon material such as carbon paper constituting conventional fuel cell is hydrophobic, it is difficult to make the surface hydrophilic. On the contrary, the surface of the porous metal sheet used for the fuel cell electrode according to the present invention is more hydrophilic than a carbon material. Therefore, when supplying, for example, a liquid fuel containing methanol is supplied to a fuel electrode, the penetration of the liquid fuel into the fuel electrode is more promoted than in the case of a traditional electrode. Fuel supply efficiency can be thereby improved.

Also, the discharge of the water produced in the electrode is promoted. For example, the porous metal sheet constituting an oxidizer electrode may be subjected to a given hydrophobic treatment to thereby provide a hydrophilic region and a hydrophobic region in the electrode with ease. By this measures, a water discharge passage is properly secured in the oxidizer electrode and this suppresses flooding. As a result, the expected output can be stably exhibited.

At this time, a hydrophobic material may be disposed in the voids of the porous metal sheet according to the need. This further promotes the discharge of water in the electrode, and also, a gas passage is properly secured. Accordingly, when, for example, the fuel cell electrode is used as an oxidizer electrode, the water produced in the oxidizer electrode can be discharged externally from the electrode.

In the fuel cell electrode of the present invention, the hydrophobic material may include a water-repellent resin. Also, the process of producing a fuel cell electrode may involve a step of sticking a water-repellent resin in the voids of the porous metal sheet.

The present invention provides a fuel cell electrode comprising a porous metal sheet and a catalyst supported by the porous metal sheet, wherein the catalyst is supported on the roughened surface of a metal constituting the porous metal sheet.

At this time, the roughing of the surface of the porous metal may be carried out by a step of etching the porous metal sheet. The degree of surface roughing can be thereby controlled simply. Here, the above etching step may be a step of etching the surface of the porous metal chemically by dipping the metal sheet in an etching solution. Also, the above step of carrying out etching may be a step of carrying out electrolytic etching by dipping the metal in an electrolytic solution.

Also, in the process of producing a fuel cell electrode according to the present invention, the process may further comprises a step of roughing the surface of a metal constituting the porous metal sheet before the step of supporting a catalyst.

According to the fuel cell electrode according to the present invention, the surface of a metal constituting the porous metal sheet is roughened and the surface area where the catalyst is supported can be therefore increased. This makes it possible to make the porous metal sheet support a sufficient amount of the catalyst directly without using a member for securing the surface area of carbon particles and the like and the electric characteristics of the electrode can be therefore improved.

The present invention provides a fuel cell electrode comprising a porous metal sheet and a catalyst supported by the porous metal sheet, wherein the porous metal sheet is a metal fiber sheet.

In the present invention, the metal fiber sheet means one obtained by molding one or more metal fibers into a sheet. The metal fiber sheet may be constituted of one type of metal fiber or may contain two or more types of metal fibers.

In the fuel cell electrode according to the present invention, the catalyst may be supported on the surface of each monofilament constituting the metal fiber sheet. Therefore, a sufficiently large amount of the catalyst to be supported can be secured. Also, conductivity required for the electrode substrate and migration passage of hydrogen ions is secured properly. Also, because the metal fiber sheet having a relatively large void ratio, the electrode can be lightened. It is to be noted that the catalyst may be fixed to the metal fiber by a proton conductor. Also, the catalyst may be plated on the surface of the metal fiber.

The fuel cell electrode of the present invention may further have a proton conductor disposed in contact with the catalyst. Also, the process of producing a fuel cell electrode may involve a step of sticking a proton conductor to the surface of the catalyst. This measures ensure that a so-called three-phase boundary between the catalyst, the fuel and the electrolyte can be formed surely and sufficiently. Also the migration passage of protons generated on the surface of the catalyst is properly secured. Therefore, the fuel cell electrode of the present invention has excellent electrode characteristics as the electrode of a fuel cell and can improve the output characteristics of a fuel cell.

In the fuel cell electrode of the present invention, the catalyst may be formed layer-like on the surface of a metal constituting the porous metal sheets. If the electrode is formed layer-like, the porous metal sheet is in plane contact with the catalyst and therefore the contact area between the porous metal sheet and the catalyst is more increased as compared with, for example, the case of a point contact structure obtained when a particle catalyst is supported. For this, the migration passage of electrons can be secured more exactly.

For example, in the fuel cell electrode of the present invention, a catalyst plating layer may be formed on the surface of a metal constituting the porous metal sheet. Also, in the process of producing the fuel cell electrode according to the present invention, the step of supporting the catalyst may involve a step of plating the porous metal sheet. This measures ensure that a desired catalyst can be supported on the surface of the porous metal sheet simply.

The fuel cell electrode of the present invention may have a structure in which porous metal sheet may be coated substantially with a catalyst. A demand in regard to functions such as corrosion resistance which are required for the material used as the porous metal sheet can be decreased. Therefore, the degree of freedom of selection of materials increases, making it possible to use a more inexpensive material.

In the process of producing the fuel cell electrode according to the present invention, the above step of roughing the surface of the metal may involve a step of etching the porous metal sheet. The degree of surface roughing can be thereby controlled simply.

In the process of producing the fuel cell electrode according to the present invention, the above etching step may involve a step of dipping the porous metal sheet in an etching solution to carry out chemical etching.

In the process of producing the fuel cell electrode according to the present invention, the above etching step may involve a step of dipping the porous metal sheet in an electrolytic solution to carry out electrolytic etching.

In the fuel cell electrode of the present invention, the catalyst is a metal or an alloy containing at least one of Pt, Ti, Cr, Fe, Co, Ni, Cu, Zn, Nb, Mo, Ru, Pd, Ag, In, Sn, Sb, W, Au, Pb and Bi, or an oxide of each of these metal or alloys.

Also, in the process of producing a fuel cell electrode according to the present invention, the above step of supporting a catalyst may involve a step of supporting a metal or an alloy containing at least one of Pt, Ti, Cr, Fe, Co, Ni, Cu, Zn, Nb, Mo, Ru, Pd, Ag, In, Sn, Sb, W, Au, Pb and Bi, or an oxide of each of these metal or alloys.

The electrochemical reaction on the surface of the electrode can be thereby run surely and effectively.

The fuel cell electrode of the present invention may be provided with a flattened layer having a proton conductivity on at least one surface of the porous metal sheet. Also, the process of producing a fuel cell electrode according to the present invention may involve a step of forming a flattened layer on at least one surface of the porous metal sheet. The adhesion of the sheet to the solid electrolyte film is thereby improved. Therefore, the migration passage of hydrogen ions can be secured exactly.

According to the present invention, a fuel cell is provided which comprises a fuel electrode, an oxidizer electrode and a solid electrolyte film sandwiched between the fuel electrode and the oxidizer electrode, wherein the fuel electrode or the oxidizer electrode is a fuel cell electrode.

Also, according to the present invention, there is provided a process of producing a fuel cell, the process comprising a step of obtaining a fuel cell electrode by the above process of producing a fuel cell electrode and a step of bonding the solid electrolyte film with the fuel cell electrode by applying the solid electrolyte film to the fuel cell electrode under pressure in the condition that the solid electrolyte film is in contact with the fuel cell electrode.

Since the fuel cell of the present invention uses the fuel cell electrode, it is superior in the utilization efficiency of the catalyst and collecting efficiency and therefore exhibits high output stably. Also, the fuel cell of the present invention uses the electrode in which the catalyst is bonded directly to the surface of the porous metal sheet. Therefore, even if a collecting member such as an end plate is not disposed outside of the electrode, current can be efficiently collected. Also, the structure and production process can be simplified and the fuel cell can be made to be a thin type, small-sized and light weight one. Also, because the step of supporting the catalyst on carbon particles is not essential, a fuel cell can be produced more simply.

In the fuel cell of the present invention, members such as package members which do not inhibit miniaturization may be properly used.

In the fuel cell of the present invention, the fuel cell electrode may constitute a fuel electrode to supply fuel directly to the surface of the fuel cell electrode. A specific structure in which fuel is directly supplied means, for example, structures in which a fuel container or a fuel supply part is disposed in contact with the porous metal sheet of the fuel electrode and fuel is supplied to the fuel electrode not through the collecting member such as an end plate. When the porous metal sheet has a plate form, through-holes and stripe lead-in grooves may be disposed on its surface optionally. Fuel can be supplied more efficiently to the whole electrode from the surface of the porous metal sheet.

Also, in the fuel cell of the present invention, the fuel cell electrode may constitute the oxidizer electrode to supply an oxidizer to the surface of the fuel cell electrode. Here, the direct supply of an oxidizer means that an oxidizer such as air or oxygen is directly supplied to the surface of the oxidizer electrode not through an end plate or the like.

Plural fuel cells according to the present invention may be combined with each other in parallel or in series to form a assembled battery or a stuck structure. This makes it possible to attain small-sized and light weight combinational batteries or stuck structures, and also to exhibit high output stably.

According to the present invention, as mentioned above, a fuel cell can be small-sized and lightened by making a porous metal support a catalyst and by disposing a proton conductor in contact with the catalyst. Also, according to the present invention, the output characteristics of a fuel cell can be improved. Moreover, according to the present invention, a process of producing a fuel cell can be simplified.

### BRIEF DESCRIPTION OF THE DRAWINGS

The aforementioned objectives and other objectives, novel features, and advantages will be apparent more clearly by the preferred embodiments described below and the accompanying drawings.

FIG. 1 is a sectional view typically showing the structure of a fuel cell in this embodiment.

FIG. 2 is a sectional view typically showing the structure of a fuel electrode and a solid electrolyte film in the fuel cell of FIG. 1.

FIG. 3 is a sectional view typically showing the structure of a fuel electrode and a solid electrolyte film in a traditional fuel cell.

FIG. 4 is a sectional view typically showing the structure of a fuel electrode and a solid electrolyte film in a fuel cell of an embodiment.

### DETAILED DESCRIPTION OF THE INVENTION

A fuel cell electrode according to the present invention and a fuel cell using the electrode will be hereinafter explained in detail.

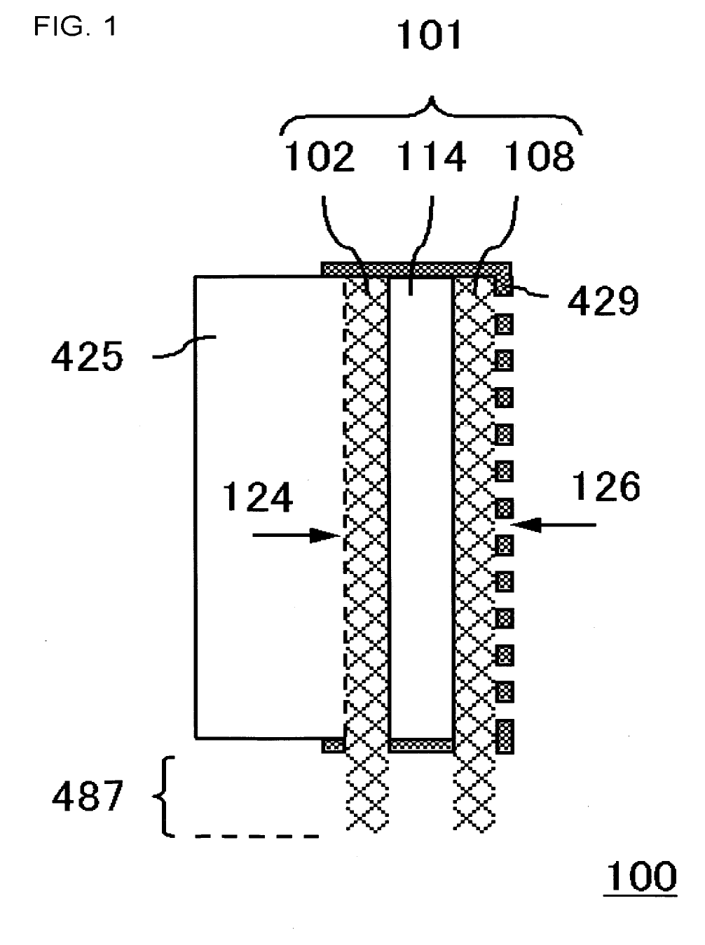

FIG. 1 is a sectional view typically showing the structure of a fuel cell 100 in this embodiment. A single cell structure 101 is constituted of a fuel electrode 102, an oxidizer electrode 108 and a solid electrolyte film 114. A combination of the fuel electrode 102 and the oxidizer electrode 108 is also called a catalyst electrode. A fuel 124 is supplied to the fuel electrode 102 through a fuel container 425. Also, though the exposed part of the single cell structure 101 is coated with a seal 429, a hole is formed to supply an oxidizer 126 to the oxidizer electrode 108 and actually oxygen in the air is supplied as the oxidizer 126. Each one end of the fuel electrode 102 and the oxidizer 108 is projected from the solid electrolyte film 114 to form a collecting part 487. The power generated in the fuel cell 100 is taken out of the collecting part 487.

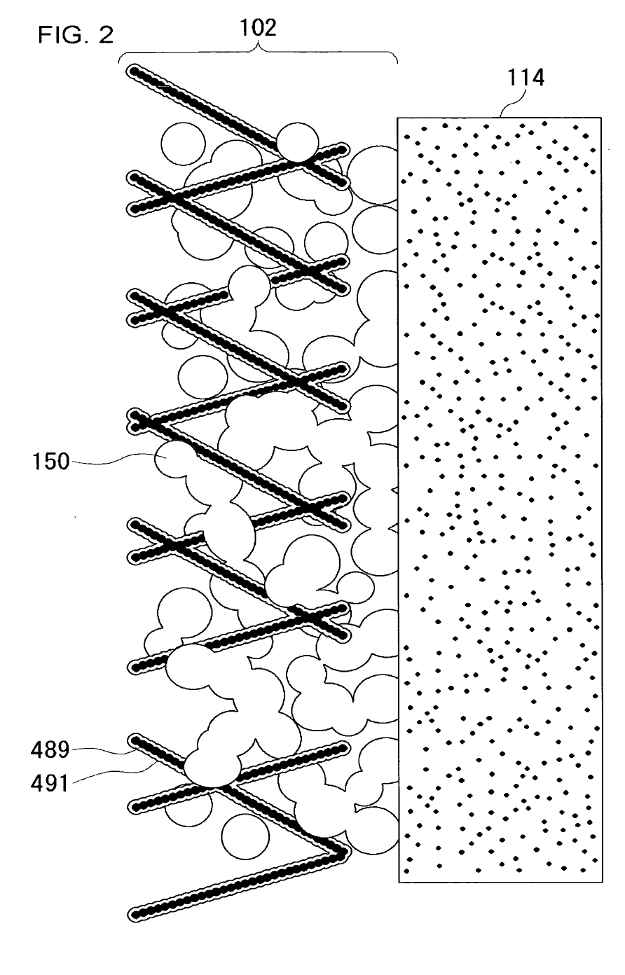

Also, FIG. 2 is a sectional view typically showing the structure of the fuel electrode 102 and the solid electrolyte film 114 in the fuel cell of FIG. 1. As illustrated, the fuel electrode 102 has a structure in which a metal constituting a porous metal sheet 489 which is a substrate has an irregular surface, which is coated with a catalyst 491. Also, as will be mentioned later, the solid electrolyte film 114 is bonded by, heating under pressure to the catalyst 491 layer supported by plating on the surface of the porous metal sheet 489 roughened by etching. By this treatment, solid high-molecular electrolyte particles 150 are stuck to the catalyst 491 layer as shown in the drawing.

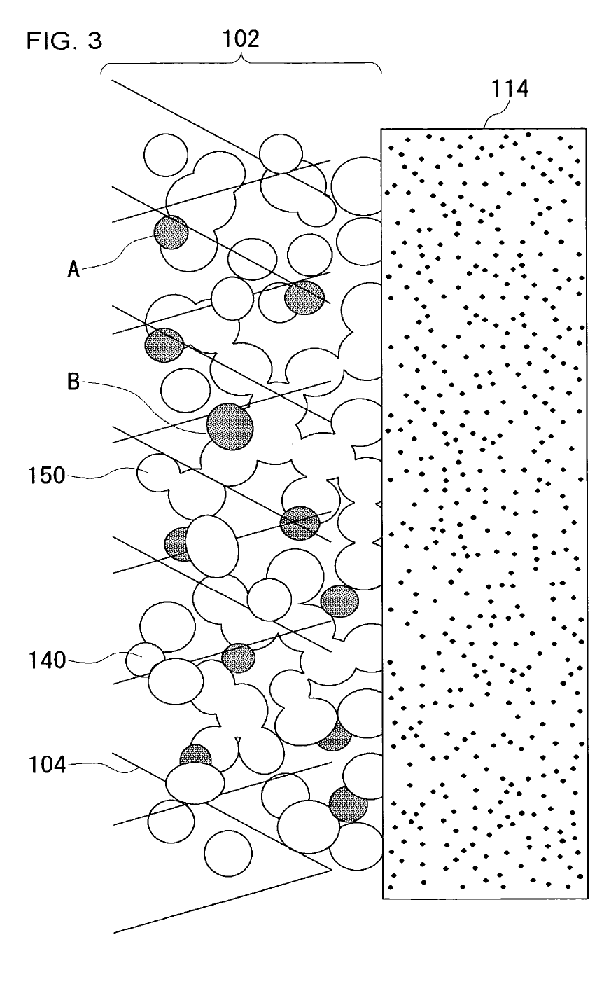

In the meantime, FIG. 3 is a sectional view typically showing the structure of a fuel electrode in a traditional fuel cell. In FIG. 3, a sheet made of a carbon material is used as a substrate 104. A catalyst layer comprising solid high-polymer electrolytic particles 150 and catalyst supporting carbon particles 140 is formed on the surface of the sheet.

The feature of the fuel cell of FIG. 1 will be explained by comparing FIG. 2 with FIG. 3. First, in FIG. 2, the porous metal sheet 489 is used as the substrate of the fuel electrode 102. Because the porous metal sheet 489 has high conductivity, it is unnecessary to provide a collecting member outside of the electrode in the fuel cell 100. On the other hand, in FIG. 3, a carbon material is used as the substrate 104, the collecting member is necessary.

When a fuel cell is applied to portable devices, it is required for the fuel cell not only to have fundamental performances such as large energy density and output density but also to be a small-sized, thin and light weight one. Because, the porous metal sheet 489 is used as the substrate of the fuel electrode 102 or oxidizer electrode 108 in the fuel cell 100, it is possible to correct current directly without providing any collection member outside of the electrode. The single cell structure 101 can be thereby lightened and thinned.

Also, in FIG. 2, the catalyst 491 is supported on the surface of a metal constituting the porous metal sheet 489. Because the surface of a metal constituting the porous metal sheet 489 has a fine irregular structure, a surface area enough to support a sufficient amount of the catalyst 491 is secured. It is therefore possible to support the catalyst 491 to the same extent as in the case of using the catalyst support carbon particles 140 as shown in FIG. 3. In this case, the porous metal sheet 489 may be subjected to water-repellent treatment.

Also, the electrochemical reaction at the fuel electrode 102 is produced at a so-called three-phase boundary between the catalyst 491, the solid high-molecular electrolyte particles 150 and the porous metal sheet 489 and it is therefore important to secure the three-phase boundary. In FIG. 2, the porous metal sheet 489 is in direct contact with the catalyst 491. Therefore, the contact parts between the catalyst 491 and the solid high-molecular electrolyte particles 150 are all three-phase boundaries and a migration passage of electrons is secured between the collecting part 487 and the catalyst 491.

In FIG. 3, on the other hand, among the catalyst support carbon particles 140, only those which are in contact with both the solid high-molecular electrolyte particles 150 and the substrate 104 are effective. Therefore, the electrons produced on the surface of the catalyst (not shown) supported on, for example, the catalyst support carbon particles A are taken out of the cell through the substrate 104. Even if electrons are produced on the surface of the catalyst supported on the surface of the carbon particles in the case of particles such as catalyst support carbon particles B which are not in contact with the substrate 104, these electrons cannot be taken out of the cell. Also, with regard to the catalyst support carbon particles A, the contact resistance between the catalyst support carbon particles 140 and the substrate 104 is larger than the contact resistance between the catalyst 491 and the porous metal sheet 489, showing that the structure shown in FIG. 2 may be said to secure a migration passage of electrons more ideally.

When comparing FIG. 2 with FIG. 3 in the above manner, the structure of FIG. 2 improves the utilization efficiency and collecting efficiency of the catalyst 491. Therefore, the output characteristics of the fuel cell 100 can be improved.

Also, in the fuel cell 100, the fuel 124 is directly supplied from the whole surface of the fuel electrode 102, the efficiency of supplying the fuel 124 becomes high and the efficiency of the catalytic reaction can be improved. Also, the contact resistance at the boundary between the electrode substrate and the collecting member does not appear and therefore, a rise of internal resistance can be limited, which allows high output characteristics to be exhibited.

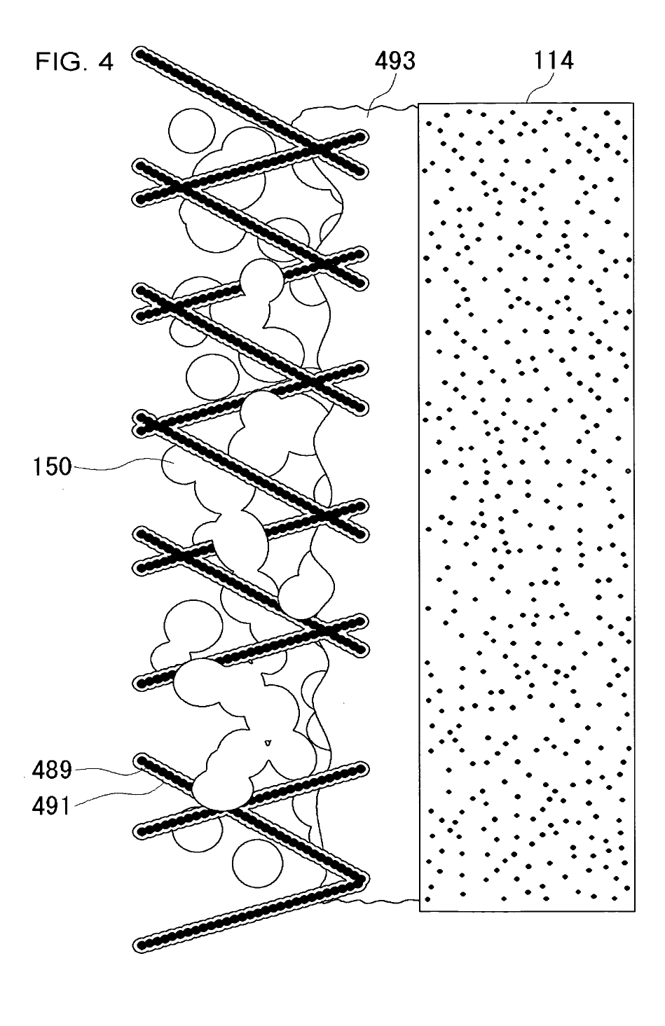

FIG. 4 is a sectional view typically showing another structure of a fuel electrode 102 and a solid electrolyte film 114. FIG. 4 is a structure provided with a flattened layer 493 on the surface of the porous metal sheet 489 in the structure shown in FIG. 2. The provision of the flattened layer 493 improves the adhesion between the solid electrolyte film 114 and the porous metal sheet 489.

In the fuel cell 100, any sheet having various structures and thicknesses may be used as the porous metal sheet 489 without any particular limitation insofar as it is provided a through-hole which penetrates both surfaces and permits fuel, oxidizers, hydrogen ions to pass through the sheet. For example, a porous metal thin plate may be used. Also, a metal fiber sheet may be used. Any metal fiber sheet may be used as the metal fiber sheet without any particular limitation insofar as one or more metal fibers are molded into a sheet form, and a nonwoven sheet of metal fibers or woven fabrics may be used. The use of a nonwoven sheet or woven fabric of metal fibers ensures that conductivity suitable to the porous metal sheet 489 and a migration passage of hydrogen ions is formed whereby electrode characteristics can be surely improved. Also, these metal fiber sheets each have a relatively large void ratio and it is therefore possible to lighten the electrode. The metal fiber sheet may be constituted of one type of metal fiber or may contain two or more types of metal fibers. The diameter of the metal fiber may be designed to be, for example, 10 μm or more and 100 μm or less.

Also, as shown in FIG. 2, it is more preferable that an irregular structure be formed on the surface of a metal constituting the porous metal sheet 489 by, for example, surface roughing treatment. By this treatment, the surface area for supporting the catalyst can be increased.

The width of a void of the porous metal sheet 489 may be designed to be for example, 10 mm or more and 5 mm or less. This ensures that it is possible to maintain good diffusion of a fuel liquid and fuel gas. Also, the void ratio of the porous metal sheet 489 may be designed to be 10% or more and 70% or less. If the ratio is 10% or more, it is possible to maintain good diffusion of a fuel liquid and fuel gas. If the ratio is 70% or less, it is possible to maintain good collecting ability. Further, the void ratio may be designed to be 30% or more and 60% or less. If the void ratio is in this range, it is possible to maintain good diffusion of a fuel liquid and fuel gas and also good collecting ability. It is to be noted that the void ratio is the ratio occupied by voids in all volume. The void ratio of the porous metal sheet 489 may be calculated from, for example, its weight and volume and the specific gravity of a metal constituting the porous metal sheet 489. Also, the void ratio may be found by a mercury porosimetry.

The thickness of the porous metal sheet 489 may be designed to be, for example, 1 mm or less. If the thickness is 1 mm or less, the single cell structure 101 can be properly thinned and lightened. Also, if the thickness is 0.5 mm or less, the single cell structure can be more thinned and lightened and is therefore more preferably used for portable devices. For example, the thickness of the single cell structure may be designed to be, for example, 0.1 mm or less.

The material of the porous metal sheet 489 may contain one or two or more elements selected from the group consisting of Ti, Zr, Hf, V, Nb, Ta, Cr, Mo, W, Mn, Fe, Co, Ni, Al, Au, Ag, Cu and Pt. These elements have good conductivity. If an element selected from Au, Ag and Cu is contained, this is desirable because the specific electric resistance of the porous metal sheet 489 can be reduced. Also, if the collecting member contains an element selected from Au, Ag and Pt, a metal richer in redox potential can be used as a metal constituting the porous metal sheet 489. The corrosion resistance of the porous metal sheet 489 can be improved even if the porous metal sheet has a structure in which a part of the porous metal sheet 489 is not covered with the catalyst 491 but exposed.

Here, the porous metal sheet 489 has the characteristics as mentioned above and therefore the above sheet may doubles as a gas diffusion electrode and a collecting electrode.

It is to be noted that the porous metal sheet 489 to be used as the fuel electrode 102 and as the oxidizer electrode 108 may be made of the same materials or different materials.

Examples of the material to be used as the catalyst 491 of the fuel electrode 102 include metals or alloys containing at least one of Pt, Ti, Cr, Fe, Co, Ni, Cu, Zn, Nb, Mo, Ru, Pd, Ag, In, Sn, Sb, W, Au, Pb and Bi or their oxides. Metals or alloys containing at least one type of Pt, Ru, V, Cr, Fe, Co and Ni or their oxides are preferably used because catalyst activity is obtained stably. Among these metal materials, Pt is particularly preferably used. In the meantime, as the catalyst (not shown) of the oxidizer electrode 108, the same one as the catalyst 491 may be used, the above exemplified materials may be used and, among these materials, a Pt—Ru alloy is particularly used. In this case, the same ones or different ones may be used as the catalysts of the fuel electrode 102 and the oxidizer electrode 108.

It is only required for the catalyst 491 to be supported by the porous metal sheet 489. All or a part of the collecting part 487 may be coated with the catalyst 491. When the entire surface of the porous metal sheet 489 is coated with the catalyst 491 as shown in FIG. 2, this limits the corrosion of the porous metal sheet 489 and is therefore preferable. When the surface of a metal constituting the porous metal sheet 489 is coated with the catalyst 491, the thickness of the catalyst 491 may be designed to be, for example, 1 nm or more and 500 nm or less though there is no particular limitation to the thickness.

The solid high-molecular electrolyte which is the material of the solid high-molecular electrolyte particles 150 has a role in electrically connecting the carbon particles supporting the catalyst with the solid electrolyte film 114 and in making an organic liquid fuel reach the surface of the catalyst. Proton conductivity is demanded of the solid high-molecular electrolyte. Further, transmittance for organic liquid fuels such as methanol is demanded of the solid high-molecular electrolyte in the fuel electrode 102 and transmittance for oxygen is demanded of the solid high-molecular electrolyte in the oxidizer electrode 108. As the solid high-molecular electrolyte, materials superior in proton conductivity and transmittance for organic liquid fuels such as methanol are preferably used to satisfy these demands. Specifically, organic polymers having a polar group including a strong acid group such as a sulfone group or phosphoric acid group or a weak acid group such as a carboxyl group may be preferably used. As such an organic polymer, specifically, fluorine-containing polymers having a fluororesin skeleton or a protonic acid group may be used. A polyether ketone, polyether ether ketone, polyether sulfone, polyether ether sulfone, polysulfone, polysulfide, polyphenylene, polyphenylene oxide, polystyrene, polyimide, polybenzoimidazole, polyamide or the like may be used. Also, a hydrocarbon type material containing no fluorine may be used as the polymer from the viewpoint of decreasing the crossover of liquid fuel such as methanol. Further, a polymer containing an aromatic group may be used as the polymer of the substrate.

Also, examples of materials which may be used as the polymer of the substrate which is a subject to which a protonic acid group is bonded include:

resins having nitrogen or a hydroxyl group such as polybenzoimidazole derivatives, polybenzoxazole derivatives, polyethyleneimine crosslinked bodies, polysilamine derivatives, amine substituted polystyrenes, e.g., polydiethylaminoethylstyrene, and nitrogen substituted polyacrylates, e.g., polydiethylaminoethylmethacrylate;

hydroxyl group-containing polyacryl resins represented by silanol-containing polysiloxane and polyhydroxyethylmethacrylate; and

hydroxy group-containing polystyrene resins represented by poly(p-hydroxystyrene).

Also, those obtained by introducing a crosslinkable substituent, such as a vinyl group, epoxy group, acryl group, methacryl group, cinnamoyl group, methylol group, azide group or naphthoquinonediazide group properly into the polymers exemplified above may also be used. Also, those in which these substituents are crosslinked may also be used.

Specifically, for example:

sulfonated polyether ketones;

sulfonated polyether ether ketones;

sulfonated polyether sulfones;

sulfonated polyether ether sulfones;

sulfonated polysulfones;

sulfonated polysulfides;

sulfonated polyphenylenes;

aromatic-containing polymers such as sulfonated poly(4-phenoxybenzoyl-1,4-phenylene) and alkylsulfonated polybenzoimidazole;

sulfoalkylated polyether ether ketones;

sulfoalkylated polyether sulfones;

sulfoalkylated polyether ether sulfones;

sulfoalkylated polysulfones;

sulfoalkylated polysulfides;

sulfoalkylated polyphenylenes;

sulfonic acid group-containing perfluorocarbon (e.g. Nafion (trademark, manufactured by E. I. du Pont de Nemours and Company) and Aciplex (manufactured by Asahi Kasei Corp.));

carboxyl group-containing perfluorocarbons (e.g., Flemion (trademark), S film (manufactured by Asahi Glass Co., LTD.));

copolymers such as polystyrenesulfonic acid copolymers, polyvinylsulfonic acid copolymers, crosslinked alkylsulfonic acid derivatives and fluorine-containing polymers comprising a fluorine resin skeleton and sulfonic acid; and

copolymers obtained by copolymerizing acrylamides such as acrylamide-2-methylpropanesulfonic acid and acrylates such as n-butylmethacrylate; may be used as the first solid high-molecular electrolyte 150 or the second solid high-molecular electrolyte 151. Aromatic polyether ether ketones or aromatic polyether ketones may also be used.

Among these compounds, sulfone group-containing perfluorocarbons (Nafion (trademark, manufactured by E. I. du Pont de Nemours and Company) and Aciplex (manufactured by Asahi Kasei Corp.)) and carboxyl group-containing perfluorocarbons (Flemion (trademark), S film (manufactured by Asahi Glass Co., LTD.)) are preferably used.

The aforementioned solid high-molecular electrolytes used for the fuel electrode 102 and for the oxidizer electrode 108 may be the same or different.

The solid electrolyte film 114 serves to make the fuel electrode 102 apart from the oxidizer electrode 108 and to migrate hydrogen ions between the both. For this, the solid electrolyte film 114 is preferably a film having high proton conductivity. Also, the solid electrolyte film 114 is preferably chemically stable and has high mechanical strength.

As the material constituting the solid electrolyte film 114, those containing a protonic acid group such as a sulfonic acid group, sulfoalkyl group, phosphoric acid group, phosphonic group, phosphine group, carboxyl group and sulfonimide group may be used. As the polymer of the substrate which is a subject to which a protonic acid group is bonded, a film of polyether ketone, polyether ether ketone, polyether sulfone, polyether ether sulfone, polysulfone, polysulfide, polyphenylene, polyphenylene oxide, polystyrene, polyimide, polybenzoylimidazole or polyamide may be used. Also, a film of a hydrocarbon type containing no fluorine may be used as the polymer from the viewpoint of reducing the crossover of liquid fuel such as methanol. Moreover, as the polymer of the substrate, polymers containing an aromatic may also be used.

Also, as the polymer of the substrate to which a protonic acid group is bonded, for example:

resins having nitrogen or a hydroxyl group such as polybenzoimidazole derivatives, polybenzoxazole derivatives, polyethyleneimine crosslinked bodies, polysilamine derivatives, amine substituted polystyrenes, e.g., polydiethylaminoethylstyrene, and nitrogen substituted polyacrylates, e.g., polydiethylaminoethylmethacrylate;

hydroxyl group-containing polyacryl resins represented by silanol-containing polysiloxane and polyhydroxyethylmethacrylate; and

hydroxy group-containing polystyrene resins represented by poly(p-hydroxystyrene) may be used.

Also, those obtained by introducing a crosslinkable substituent, such as a vinyl group, epoxy group, acryl group, methacryl group, cinnamoyl group, methylol group, azide group or naphthoquinonediazide group properly into the polymers exemplified above may also be used. Also, those in which these substituents are crosslinked may also be used.

Specifically, for example:

sulfonated polyether ether ketones;

sulfonated polyether sulfones;

sulfonated polyether ether sulfones;

sulfonated polysulfones;

sulfonated polysulfides;

sulfonated polyphenylenes;

aromatic-containing polymers such as sulfonated poly(4-phenoxybenzoyl-1,4-phenylene) and alkylsulfonated polybenzoimidazole;

sulfoalkylated polyether ether ketones;

sulfoalkylated polyether sulfones;

sulfoalkylated polyether ether sulfones:

sulfoalkylated polysulfones;

sulfoalkylated polysulfides;

sulfoalkylated polyphenylenes;

sulfonic acid group-containing perfluorocarbons (e.g., Nafion (trademark, manufactured by E. I. du Pont de Nemours and Company) and Aciplex (manufactured by Asahi Kasei Corp.));

carboxyl group-containing perfluorocarbons (e.g., Flemion (trademark), S film (manufactured by Asahi Glass Co., LTD.));

copolymers such as polystyrenesulfonic acid copolymers, polyvinylsulfonic acid copolymers, crosslinked alkylsulfonic acid derivatives and fluorine-containing polymers comprising a fluororesin skeleton and sulfonic acid; and

copolymers obtained by copolymerizing acrylamides such as acrylamide-2-methylpropanesulfonic acid and acrylates such as n-butylmethacrylate; may be used as the solid electrolyte film 114. Aromatic polyether ether ketones or aromatic polyether ketones may also be used.

In this embodiment, as the solid electrolyte film 114, the first solid high-molecular electrolyte 150 and the second solid high-molecular electrolyte 151, materials which scarcely transmit organic liquid fuels are preferably used from the viewpoint of suppressing crossover. These electrolyte materials may be preferably constituted of aromatic condensed type polymers such as sulfonated poly(4-phenoxybenzoyl-1,4-phenylene) and alkyl sulfonated polybenzoimidazole. The degree of swelling of each of solid electrolyte film 114 and the second solid high-molecular electrolyte 151 in methanol is designed to be preferably 50% or less and more preferably 20% or less (swelling ability in an aqueous 70 vol % MeOH solution). This ensures that particularly high interface adhesiveness and proton conductivity are obtained.

When the flattened layer 493 is formed on the surface of the porous metal sheet 489, the flattened layer 493 may be served as the proton conductor. A migration passage of hydrogen ions is appropriately formed between the solid electrolyte film 114 and the catalyst electrode. The material of the flattened layer 493 is selected from, for example, materials used for the solid electrolyte or solid electrolyte film 114.

Also, as the fuel 124 used in this embodiment, for example, hydrogen may be used. Also, reformed hydrogen obtained from fuel sources such as natural gas and naphtha may also be used. Alternatively, liquid fuel such as methanol may be directly supplied. Also, as the oxidizer 126, for example, oxygen or air may be used.

As to a method of supplying liquid fuel when liquid fuel is directly supplied to the fuel cell, for example, the fuel may be supplied from the fuel container 425 bonded to the fuel electrode 102. The fuel 124 is supplied from holes formed on the surface which is in contact with the porous metal sheet 489 of the fuel container 425. It is possible to adopt a structure in which a fuel supply port (not shown) is provided in the fuel container 425 to pour the fuel 124 according to the need. A fuel supply structure may be adopted in which the fuel 124 is stored in the fuel container 425 or the fuel 124 is transported to the fuel container 425 at any time. Specifically, the method of supplying the fuel 124 is not limited to the method using the fuel container 425 and for example, a method in which a fuel supply conduit is provided may be selected properly. For example, a fuel supply structure in which the fuel 124 is transported to the fuel container 425 from a fuel cartridge.

Next, the fuel cell electrode and fuel cell in this embodiment may be manufactured in the following manner though no particular limitation is imposed on the manufacturing methods.

When a metal fiber sheet is used as the porous metal sheet 489, the metal fiber sheet may be obtained by compression-molding metal fibers and as required, by compression-sintering the molded fiber.

For example, etching such as electrochemical etching or chemical etching may be used as a method of forming a fine irregular structure on the surface of a metal constituting the porous metal sheet 489.

As the electrochemical etching, electrolytic etching using an anode polarization may be carried out. At this time, the porous metal sheet 489 is dipped in an electrolytic solution to apply a d.c. voltage of about 1 V to 10 V. As the electrolytic solution, an acidic solution such as hydrochloric acid, sulfamic acid, supersaturated oxalic acid and phosphoric acid-chromic acid mixed solution may be used.

Also, when chemical etching is carried out, the porous metal sheet 489 is dipped in an etching solution containing an oxidizer. As the etching solution, for example, nitric acid, an alcohol nitrate solution (nital), alcohol picrate (picril) or a ferric chloride solution is used.

The porous metal sheet 489 having metal fibers formed with an irregular structure on the surface thereof is made to support a metal to be the catalyst 491 in this manner. As a method of supporting the catalyst 491, for example, a plating method such as electro plating or electroless plating, or a vapor deposition method such as a vacuum deposition method or chemical vapor deposition (CVD) method may be used.

When electroplating is carried out, the porous metal sheet 489 is dipped in an aqueous solution containing target catalyst metal ions to apply a d.c. voltage of about 1 V to 10 V. In the case of carrying out, for example, Pt plating, Pt(NH₃)₂(NO₂)₂, (NH₄)₂PtCl₆or the like may be added in an acidic solution of sulfuric acid, sufamic acid or ammonium phosphate to carry out plating at a current density of 0.5 to 2A/dm². Also, in the case of carrying out plating with plural metals, voltage is controlled in a concentration range where one metal is in a diffusion-controlling region, whereby the plating with metals can be carried out in a desired ratio.

Also, in the case of carrying out electroless plating, a reducing agent such as sodium hypophosphite or sodium borohydride is added as the reducing agent in an aqueous solution containing intended catalyst metal ions, for example, Ni, Co, Cu and the porous metal sheet 489 is dipped in this solution to heat the solution to about 90° C. to 100° C.

The fuel electrode 102 and the oxidizer electrode 108 are obtained in the above manner. Hydrophobic material may be stuck to the inside of voids of the porous metal sheet 489 to form a hydrophobic region. For example, the surface of the porous metal sheet 489 may be subjected to water-repellent treatment. If this water-repellent treatment is carried out, hydrophilic surfaces of the catalyst 491 or porous metal sheet 489 and a water-repellent surface exist together to secure a discharge passage of water in the catalyst electrode properly. This makes it possible to discharge the water produced in, for example, the oxidizer electrode 108 out of the electrode properly. At this time, the water-repellent treatment may be carried out on the surface which is the outside of the fuel cell 100 at the oxidizer electrode 108.

As a method of carrying out the water-repellent treatment of the porous metal sheet 489, a method may be used in which the substrate is dipped in or brought into contact with a solution or suspension solution of a hydrophobic material such as polyethylene, paraffin, polydimethylsiloxane, PTFE, tetrafluoroethylene perfluoroalkylvinyl ether copolymer (PFA), fluoroethylenepropylene (FEP), poly(perfluorooctylethylacrylate) (FMA) or poliphosphazene, to stick a water-repellent resin to the inside of holes. A hydrophobic region is properly formed by using, particularly, a highly water-repellent material such as PTFE, tetrafluoroethylene perfluoroalkylvinyl ether copolymer (PFA), fluoroethylenepropylene (FEP), poly(perfluorooctylethylacrylate) (FMA) or poliphosphazene.

Also, a material obtained by crushing a hydrophobic material such as PTFE, PFA, FEP, fluorinated pitch or poliphosphazene and suspending the crushed material in a solvent may be applied. The coating solution may be a suspension solution of a mixture of a hydrophobic material and a conductive material such as a metal or carbon. Also, the coating solution may be one obtained by crushing a water-repellent conductive fiber, for example, Dreamaron (trademark, manufactured by Nissen (sha)) and suspending the crushed fiber. The output of the cell can be more increased by using a conductive and water-repellent material in this manner.

Also, a coating solution obtained by crushing a conductive material such as a metal or carbon, coating the crushed material with the above hydrophobic material and suspending the resulting coated material in a solvent may be applied. As to a coating method, a method such as brush coating, spray coating, screen printing or the like may be used though no particular limitation is imposed on the method. A hydrophobic region can be formed in a part of the porous metal sheet 489 by regulating the coating amount. Also, the porous metal sheet 489 having a hydrophilic surface and a hydrophobic surface is obtained by coating only one surface of the porous metal sheet 489.

Also, a hydrophobic group may be introduced into the surface of the porous metal sheet 489 or catalyst 491 by a plasma method. The thickness of the hydrophobic part can be thereby made to be a desired one. For instance, the surface of the porous metal sheet 489 or catalyst 491 may be subjected to CF₄ plasma treatment.

The solid electrolyte film 114 may be manufactured by adopting an appropriate method corresponding to the materials to be used. In the case of constituting the solid electrolyte film 114 by using an organic high-molecular material, a liquid prepared by dissolving or dispersing the organic high-molecular material in a solvent is cast on, for example, a peelable sheet such as polytetrafluoroethylene, followed by drying.

A method in which the obtained solid electrolyte film 114 is dipped in a solution of a solid high-molecular electrolyte is used to stick the solid high-molecular electrolyte to the surface of the catalyst 491. Then, the solid electrolyte film 114 is sandwiched between the fuel electrode 102 and the oxidizer electrode 108, followed by hot pressing to obtain a catalyst electrode-solid electrolyte film joined body. At this time, it is preferable to flatten the surface by disposing a solid high-molecular electrolyte layer on each surface of the fuel electrode 102 and the oxidizer electrode 108 to thereby secure a migration passage of hydrogen ions in the catalyst electrode.

The condition of the hot press is selected corresponding to the type of material. When the solid high-molecular electrolyte on the surfaces of the solid electrolyte film 114 and catalyst electrode is constituted of an organic polymer having a softening point and glass transition, the hot pressing operation may be carried out at a temperature exceeding the softening point or glass transition temperature of these polymers. Specifically, the following hot press condition is adopted: temperature: 100° C. or more and 250° C. or less, pressure: 1 kg/cm² or more and 100 kg/cm² or less and time: 10 seconds or more and 300 seconds or less. The resulting catalyst electrode-solid electrolyte film joined body is the single cell structure 101 shown FIG. 1.

The single cell structure 101 is obtained in the above manner. Since the porous metal sheet 489 is used in the single cell structure 101, the internal resistance of the fuel cell is reduced and therefore, excellent output characteristics can be exhibited.

The fuel container 425 is bound with the fuel electrode 102 of th single cell structure 101 and a seal 429 is disposed at the exposed part of the single cell structure 101. At this time, the fuel electrode 102 may be bound with the fuel container 425 by using an adhesive agent having durability to the fuel 124. If the porous metal sheet 489 is used as the substrate of the fuel electrode 102, a collecting member such as an end plate becomes unnecessary and the fuel 124 can be supplied by bringing the fuel electrode 102 into direct contact with a fuel passage or a fuel container. Therefore, a thinner, small-sized and light-weight fuel cell 100 can be obtained. The production process can be simplified by adopting such a structure.

The oxidizer electrode 108 is also brought into direct contact with an oxidizer or air to supply the oxidizer 126. It is to be noted that the oxidizer 126 may be supplied to the oxidizer electrode 108 through any member if, like a package member, this member does not inhibit miniaturization.

Because the fuel cell 100 obtained in this manner is a light-weight and small-sized one and also has high output, it may be preferably used as a fuel cell for portable devices such as portable telephone.

The invention has been described in its preferred embodiments. These embodiments are, however, illustrative and it is therefore obvious to a person skilled in the art that the combinations of each structural element and each treating process may be variously modified and these modifications are within the scope of the present invention.

For example, an electrode terminal fitting part may be provided in the fuel cell according to this embodiment and two or more of these electrode fuels are combined through the fitting part to make a assembled battery. Assembled batteries having desired voltage and capacity can be obtained by adopting the structures in which these cells are arranged in parallel or in series or in combinations of these arrangements. Also, plural fuel cells may be arranged plane-like and connected to each other to make a assembled battery. The single cell structures 101 are each laminated through a separator to form a stuck. The fuel cell of the present invention can exhibit excellent output characteristics stably when it is made into a stuck.

Also, the fuel cell of this embodiment uses the porous metal sheet having high conductivity and therefore, the electrons generated by a catalytic reaction can be taken out of the cell efficiently not only when it has a plate form but also when it has a cylinder structure.

### EXAMPLES

The fuel cell electrode and the fuel cell in the aforementioned embodiment will be hereinafter explained in detail by way of examples, which are, however, not intended to be limiting of the present invention.

### Example 1

A SUS316 type porous metal fiber sheet 0.3 mm in thickness was used as materials for a fuel electrode and an oxidizer electrode (gas diffusion electrode). This metal fiber sheet was dipped in an electrolytic solution and anode-polarized to carry out electrolytic etching. At this time, an aqueous 1N HCl solution was used and a d.c. voltage of 3 V was applied.

The electrolytically etched surface of the metal fiber sheet was observed by SEM (scanning type electron microscope) to compare the surface condition with that of an untreated metal film, to find that fine pores about several nm to several tens nm in depth were formed homogeneously on the entire surface of metal fibers constituting the electrolytically etched metal fiber sheet. On the other hand, the surface of the metal fiber constituting the untreated metal fiber sheet was flat and no fine pore was observed. It was thereby confirmed that a desired irregular structure was formed by electrolytic plating.

Next, the surface of electrolytically etched metal fiber sheet was plated with platinum about 10 to 50 nm in thickness. As a platinum salt, Pt(NH₃)₂(NO₂)₂ was used and dissolved in an aqueous sulfuric acid solution adjusted to pH 1 or less. The concentration of Pt(NH₃)₂(NO₂)₂ was made to be 10 g/l. The metal fiber sheet was dipped in this solution as a positive electrode to carry out plating by anode polarization in the condition of 70 degree and 2A/dm².

Two metal fiber sheets plated with platinum were dipped in a solid high-molecular electrolytic solution (5 wt % Nafion alcohol solution, manufactured by Aldrich Corporation) and then made to support a solid electrolyte film between them, followed by hot-pressing at 130° C. under a pressure of 10 kg/cm² to manufacture a catalyst electrode-solid electrolyte film joined body. At this time, the end of the metal fiber sheet was projected from the end of solid electrolyte film to constitute a collecting part. Also, Nafion 112 (trademark, manufactured by E. I. du Pont de Nemours and Company) was used as the solid electrolyte film.

The obtained catalyst electrode-solid electrolyte film joined body was used as a unit cell of a fuel cell and mounted on a package for evaluation. Then, an aqueous 10 v/v % methanol solution was supplied to the fuel electrode from the fuel container and air was supplied to the oxidizer electrode.

The flow rates of the fuel and oxidizer were 5 ml/min and 50 ml/min respectively. The output of this fuel cell was measured at ambient temperature (25° C.) under 1 atom, to find that an output of 0.45 V was obtained under a current of 100 mA/cm².

### Example 2

A fuel cell was manufactured and evaluated in the same manner as in Example 1 without carrying out electrolytic etching of the porous metal sheet. The resulting fuel cell had an output of about 0.4 V.

### Example 3

Platinum particles are supported on the surface of a metal fiber sheet which was surface-roughened in the same manner as in Example 1. As the solid high-molecular electrolyte, a 5 wt % Nafion alcohol solution manufactured by Aldrich Chemical Corporation was selected and mixed with n-butyl acetate with stirring such that the amount of the solid high-molecular electrolyte was 0.1 to 0.4 mg/cm³ to prepare a colloid dispersion solution of the solid high-molecular electrolyte. A platinum-ruthenium alloy catalyst having a particle diameter of 3 to 5 nm was added to the colloid dispersion solution of the solid high-molecular electrolyte to form a paste by using a ultrasonic disperser. At this time, the solid high-molecular electrolyte and the catalyst were mixed in a ratio by weight of 1:1.

This paste was applied to the metal fiber sheet in an amount of 2 mg/cm² by a screen printing method and then dried under heating to manufacture a fuel cell electrode. This electrode was applied to each surface of a solid electrolyte film Nafion 112 manufactured by E. I. du Pont de Nemours and Company at 130° C. under a pressure of 10 kg/cm² by hot pressing to manufacture a catalyst electrode-solid electrolyte film joined body.

The resulting catalyst electrode-solid electrolyte film joined body was used as a unit cell of a fuel cell to evaluate in the same manner as in Example 1, to find that the fuel cell had an output of about 0.41 V.

### Comparative Example 1

Carbon paper (manufactured by Toray) 0.19 mm in thickness was used for the base materials of the fuel electrode and oxidizer electrode (gas diffusion electrode). Also, a 0.5-mm-thick SUS plate was used as the collecting metal plate.

First, a catalyst layer was formed on the surface of the carbon paper in the following manner. As the solid high-molecular electrolyte, a 5 wt % Nafion alcohol solution manufactured by Aldrich Chemical Corporation was selected and mixed with n-butyl acetate with stirring such that the amount of the solid high-molecular electrolyte was 0.1 to 0.4 mg/cm³ to prepare a colloid dispersion solution of the solid high-molecular electrolyte. As the catalyst of the fuel electrode, catalyst support carbon fine particles prepared by making carbon fine particles (Denka Black, manufactured by Denki Kagaku Kogyo) support a platinum/ruthenium alloy catalyst having a particle diameter of 3 to 5 nm in a ratio by amount of 50% were used. As the catalyst of the oxidizer electrode, catalyst support carbon fine particles prepared by making carbon fine particles (Denka Black, manufactured by Denki Kagaku Kogyo) support a platinum catalyst having a particle diameter of 3 to 5 nm in a ratio by amount of 50% were used.

The catalyst support carbon fine particles were added to the colloid dispersion solution of the solid high-molecular electrolyte to form a paste by using a ultrasonic disperser. At this time, the solid high-molecular electrolyte and the catalyst were mixed in a ratio by weight of 1:1. This paste was applied to carbon paper in an amount of 2 mg/cm² by a screen printing method and then dried under heating to manufacture a fuel cell electrode. This electrode was applied to each surface of a solid electrolyte film Nafion 112 manufactured by E. I. du Pont de Nemours and Company at 130° C. under a pressure of 10 kg/cm² by hot pressing to manufacture a catalyst electrode-solid electrolyte film joined body.

The resulting catalyst electrode-solid electrolyte film joined body was fastened tight with a metal collecting plate and the resulting body was used as a unit cell to measure the output of the cell, to find the output to be about 0.37 V.

It is clarified from the above Examples and Comparative Examples that a superb catalyst electrode was obtained by forming irregularity on the surface of the metal fibers constituting the metal fiber sheet and by carrying out platinum plating, and a fuel cell using the catalyst electrode has high output characteristics. Also, since the fuel cell described in Example 1 uses no collecting metal plate, it is small-sized, light-weighted and thinned more greatly than the fuel cell described in Comparative Example 1.

### Example 4

As the metal fiber sheet, the same material that was used in Example 1 was used and dipped in a 0.1 mol/l ferric chloride solution for 20 minutes. The surface of the obtained metal fiber sheet was observed by SEM and as a result, an irregular structure having almost the same size as that of Example 1 was formed on the surface of the metal fiber.

A catalyst paste prepared in the same manner as in Example 3 was applied to one surface of the resulting metal fiber sheet to form a catalyst layer. Also, the other surface was dipped in a suspension solution of PTFE to carry out water-repellent treatment. This electrode was applied to each surface of a solid electrolyte film Nafion 112 manufactured by E. I. du Pont de Nemours and Company at 130° C. under a pressure of 10 kg/cm² by hot pressing to manufacture a catalyst electrode-solid electrolyte film joined body.

The output of the resulting catalyst electrode-solid electrolyte film joined body was measured in the same manner as in Example 1 and as a result, the initial output was 0.45 V and this value was not almost changed even after one month.

### Example 5

A catalyst electrode-solid electrolyte film joined body was manufactured same as in Example 4 besides not surface treatment of metal fiber sheet, and the output characteristics thereof were evaluated in the same manner as in Example 4. As a result, though the initial output was 0.4 V, the output was dropped to 0.25 V after one month.

It is clarified from Examples 4 and 5 that the output stability was improved by roughing the surface of the metal fiber. This is considered to be because a fair discharge passage of water is formed and flooding is more restricted by roughing the surface of the metal fiber.

As described in Examples 1 to 5, it is unnecessary to provide a collecting plate separately in a fuel cell and it is therefore possible to develop a light-weight fuel cell. It is also found that the initial output of the cell is increased by using a metal fiber sheet. Also, it is clarified that a reduction in output when a fuel cell is used for a long term is suppressed and high output is exhibited stably by carrying out etching of metal fibers.

1. (canceled)

2. A fuel cell electrode comprising a porous metal sheet and a catalyst supported by the porous metal sheet, wherein a catalyst is supported on the roughened surface of a metal constituting said porous metal sheet.

3. (canceled)

4. (canceled)

5. (canceled)

6. A fuel cell electrode according to claim 2, wherein said porous metal sheet is a metal fiber sheet.

7. A fuel cell electrode according to claim 2, the electrode further comprising a proton conductor disposed in contact with said catalyst.

8. A fuel cell electrode according to claim 2, wherein said catalyst is formed layer-wise on the surface of a metal constituting said porous metal sheet.

9. A fuel cell electrode according to claim 8, wherein a plating layer of said catalyst is formed on the surface of a metal constituting said porous metal sheet.

10. A fuel cell electrode according to claim 2, wherein said catalyst substantially covers said porous metal sheet.

11. A fuel cell electrode according to claim 2, wherein said catalyst is a metal or an alloy containing at least one of Pt, Ti, Cr, Fe, Co, Ni, Cu, Zn, Nb, Mo, Ru, Pd, Ag, In, Sn, Sb, W, Au, Pb and Bi, or an oxide of each of these metals or alloys.

12. A fuel cell electrode according to claim 2, wherein a hydrophobic material is disposed in voids of said porous metal sheet.

13. A fuel cell electrode according to claim 12, wherein said hydrophobic material contains a water-repellent resin.

14. A fuel cell electrode according to claim 2, wherein said porous metal sheet is provided with a flattened layer having proton conductivity on at least one surface thereof.

15. A fuel cell comprising a fuel electrode, an oxidizer electrode and a solid electrolyte film sandwiched between said fuel electrode and said oxidizer electrode, wherein said fuel electrode or said oxidizer electrode is the fuel cell electrode as claimed in claim 2.

16. A fuel cell according to claim 15, wherein said fuel cell electrode constitutes a fuel electrode and fuel is directly supplied to the surface of said fuel cell electrode.

17. A fuel cell according to claim 15, wherein said fuel cell electrode constitutes said oxidizer electrode and an oxidizer is directly supplied to the surface of said fuel cell electrode.

18. (canceled)

19. A process of producing a fuel cell electrode, the process involves a step of making said porous metal sheet supported a catalyst after a step of roughing the surface of a metal constituting a porous metal sheet.

20. A process of producing a fuel cell electrode according to claim 19, wherein said step of roughing the surface of a metal involves a step of etching said porous metal sheet.

21. A process of producing a fuel cell electrode according to claim 20, wherein said etching step involves a step of carrying out etching chemically by dipping said porous metal sheet in an etching solution.

22. A process of producing a fuel cell electrode according to claim 20, wherein said etching step involves a step of carrying out electrolytic etching by dipping said porous metal sheet in an electrolytic solution.

23. A process of producing a fuel cell electrode according to claim 19, wherein said step of supporting a catalyst involves a step of supporting a metal or an alloy containing at least one of Pt, Ti, Cr, Fe, Co, Ni, Cu, Zn, Nb, Mo, Ru, Pd, Ag, In, Sn, Sb, W, Au, Pb and Bi, or an oxide of each of these metal or alloys.

24. A process of producing a fuel cell electrode claim 19, wherein said step of supporting a catalyst involves a step of plating said porous metal sheet.

25. A process of producing a fuel cell electrode according to claim 19, the process comprising a step of sticking a proton conductor to the surface of said catalyst.

26. A process of producing a fuel cell electrode according to claim 19, the process involves a step of sticking a water-repellent resin to the inside of voids of said porous metal sheet.

27. A process of producing a fuel cell electrode according to claim 19, the process comprising a step of forming a flattened layer on at least one surface of said porous metal sheet.

28. A process of producing a fuel cell, the process comprising:
a step of obtaining a fuel cell electrode by the process of producing a fuel cell electrode as claimed in claim 19; and
a step of binding said solid electrolyte film with said fuel cell electrode by sticking said solid electrolyte film to fuel cell electrode under pressure in the condition that said solid electrolyte film is in contact with said fuel cell electrode.
